(19) United States
(12) Patent Application Publication
(10) Pub. No.: US 2019/0257942 A1
(43) Pub. Date: Aug. 22, 2019

(54) METHOD AND APPARATUS TO MINIMIZE THE EFFECTS OF RADAR ANOMALOUS PROPAGATION FOR AIR TRAFFIC CONTROL

(71) Applicant: Intersoft Electronics, Inc., McLean, VA (US)

(72) Inventors: Alexander E. Smith, McLean, VA (US); Robin Deyoe, Alexandria, VA (US)

(21) Appl. No.: 16/279,672

(22) Filed: Feb. 19, 2019

Related U.S. Application Data
(60) Provisional application No. 62/632,628, filed on Feb. 20, 2018.

(51) Int. Cl. G01S 13/95; G01S 13/91; G08G 5/00

(52) U.S. Cl. CPC G01S 13/953; G08G 5/0091; G01S 13/91

(57) ABSTRACT

To minimize the effects of radar anomalous propagation for air traffic control, the range of a radar terminal is extended to build an extended clutter map, and the extended clutter map in turn is used to identify areas in radar returns where anomalous propagation may be falsely reporting ground clutter as weather. The extended clutter map includes a database of radar returns, and the method includes the step of comparing ongoing radar returns with the radar returns in the database to detect matches or correlations. To utilize existing radar terminals, the operating range of the existing terminal is extended with a higher-efficiency radar transmitter, higher-sensitivity receiver, or both. The performance improvement is in the range of 6 to 10 dB or more. The increased receiver sensitivity allows a greater volume of receive beam sampling and therefore an increased number of Doppler filter banks in which to detect and classify target primitives.

### REFERENCE TO RELATED APPLICATIONS

This invention application claims priority to, and the benefit of, U.S. Provisional Patent Application Ser. No. 62/632,628, filed Feb. 20, 2018, the entire content of which is incorporated herein by reference.

### FIELD OF THE INVENTION

This invention relates generally to Anomalous Propagation (AP) and, more particularly, to methods and apparatus for minimizing AP for air traffic control using extended clutter mapping.

### BACKGROUND OF THE INVENTION

Anomalous Propagation (AP) is a phenomenon known throughout the field of radar engineering whereby certain meteorological conditions such as pressure, temperature and water vapor, can cause changes in the refractive index of the atmosphere, effectively bending the path of a radar's beam. Under certain conditions the radar beam can become trapped in the atmosphere, in an abnormality known as ducting, producing false returns from the ground. The presence and science of AP has been covered extensively in the literature (Doviak and Zrni\grave{c}, 1984; Meischner et al., 1997) and incorporated herein by reference.

All terminal radar systems are subject to the effects of anomalous propagation: a phenomenon that can cause beam bending and erroneous clutter returns, leading to false weather reports. The FAA currently has three types of terminal radars in the National Airspace System, ranging from the older ASR-8, to the newer ASR-9 and ASR-11, illustrated in FIG. 1.

The ASR-8 is an older, klystron-based system which was not designed with a separate weather channel, while the ASR-9 (also klystron-based) and the ASR-11 (solid state) both have separate, dedicated weather channels. All three of these systems have experienced false weather issues over the years resulting from anomalous propagation.

However, even with a separate weather channel and specialized weather processing functions, extensive ASR-9 deployment in the 1990s highlighted many issues with AP causing ground clutter breakthrough (Weber et al., 1991, incorporated herein by reference). According to Cullen (1996), incorporated herein by reference, the ASR-9's weather channel use of “aggressive spatial and temporal smoothing” caused clutter breakthrough that was “largely indistinguishable from actual meteorological echoes.” Similarly, after deployment, the ASR-11 experienced unwanted effects of AP on weather measurement. Therefore, even with separate weather channels and various design processing features, radar systems newer than the ASR-8 continued to suffer from the effects of AP.

ASRs older than the ASR-9, e.g., the ASR-8, receive both weather and target information from the same channel. As evaluated by MIT's Lincoln Laboratory, when the ASR-8 is operated with circular polarization (CP), weather returns decrease by up to 18 dB at the expense of improving target detection, as detailed by Puzzo et al., 1989, and incorporated herein by reference. This is not an issue with the ASR-9 and ASR-11 due to dedicated channels allowing independent selection of polarization for weather and target detection. Furthermore, the FAA's specification for the ASR-9 calls for a separate weather processor that performs temporal and spatial smoothing, as described by FAA, 1986, incorporated herein by reference. (Puzzo, D. C., Troxel, S. W., Meister, M. A., Weber, M. E., Pieronek, J. V., ASR-9 Weather Channel Test Report, 3 May 1989. Project Report ATC-165, Lincoln Laboratory, p. 4).

In the last twenty years or so, the FAA has embarked on various technical evaluations and modification programs to adapt the newer ASR-9 and ASR-11 to mitigate anomalous propagation. Fundamentally, these mitigation approaches have relied on spectral isolation (filtering) of perceived false and true weather, for which the full deployment results are not presently published or otherwise readily available. ASR-11 modifications are currently underway, and although it is believed that these modification outcomes are somewhat positive, complete quantified data are not yet readily available.

### ASR-9/11 AP Mitigation Modifications

Weber (2002), incorporated herein by reference, describes potential radar hardware and software design enhancements, inter alia, to mitigate the effects of AP in the ASR-9. Specifically, Weber characterizes AP as clutter returns with extremely low Doppler velocity and relatively high spectrum widths as follows:

“For stationary clutter signals with near-zero mean Doppler velocity and spectrum widths dominated by antenna scan modulation (0.72 m/s for the ASR-9), this ratio will of course approach 20 dB. Meteorological echoes often have non-zero mean Doppler velocities and almost always exhibit spectrum widths well in excess of the scan-modulation limit. Thus, the filter input/output power ratio will be significantly lower. A threshold of 11 dB for this ratio has been found to reliably differentiate meteorological returns from ground clutter. If the filter input/output power ratio is less than this threshold, processing proceeds with the unfiltered data. Otherwise, the data for this resolution cell are flagged as AP contaminated.”

Essentially, the characterization of false weather in this instance is, in part, clutter returns that are reported as static or extremely slow moving: i.e., where the comparison between actual returns and the radar's clear air map yields high clutter returns that are fundamentally motionless. Filtering solely on movement, of course, would also eliminate some authentic stationary weather situations. Weber's reference to higher spectrum widths of meteorological returns is well described by measuring the spatial variability of Doppler velocities (Fang, 2001, incorporated herein by reference). Here, Fang describes Doppler spatial variability through spectrum measurements as a principal means to identify weather that is considered dangerous for safe flight conditions. Consequently, Weber describes a hardware/software architecture that employs a bank of filters and decision logic to flag and eliminate false weather, based on low Doppler velocity and high spectral content (See FIG. 2).

In 2004, the FAA fielded an ASR-9 modification implementing an approach using both low Doppler velocity and high spectral content filtering to suppress AP. That modification enhanced AP mitigation in the ASR-9, and a similar modification is currently underway with the ASR-11. The quantified extent of weather detection improvements and AP suppression through these modifications in the field is as yet undetermined.

### Present Radar AP Mitigation Limitations

There are several general limitations of the approaches used for the ASR-9 and ASR-11 AP mitigation. (1) Firstly, a low velocity Doppler filters may mischaracterize slow moving weather as AP, and secondly (2), weather Doppler spreading is only more pronounced for more violent wind conditions. Fang (2001, pp. 56-59), incorporated herein by reference, characterizes the spectral spread of various weather conditions ranging from small to large as isolated supercells, stratiform rain and snow (all low spectrum), to widespread rain showers and multi-cell severe storms (medium spectrum), to squalls (high spectrum). Therefore, a filter approach based on the two factors here may mis-identify significant weather in many instances, incorrectly classifying real weather events as AP, for subsequent flagging and elimination.

### Weather Radar and AP Mitigation

Dedicated weather radars mitigate AP by using narrow pencil beams to track the horizon and at various elevations, essentially using elevation filtering, as proposed herein. Unfortunately, these methods require more time to update weather imagery: five minutes or so for a complete picture (NOAA, 2017), incorporated herein by reference, whereas ASR weather is required within seconds in the airport vicinity for ATC purposes. The ASR-9 specification requires that a “six-level weather channel shall provide updated weather information on the ATC display within the internal of nine scans or less.” (FAA, 1986, p. 15). It is therefore not practical to consider some elaborate approach that does not meet the latency for air traffic control, but instead to select a method that meets ASR requirements while adequately suppressing AP.

### SUMMARY OF THE INVENTION

This invention is directed to minimizing the effects of radar anomalous propagation for air traffic control. In accordance with a method aspect of the invention, the range of a radar terminal is extended to provide an extended operating range. This extended range is used to build an extended clutter map, and the extended clutter map in turn is used to identify areas in radar returns where anomalous propagation may be falsely reporting ground clutter as weather.

The extended clutter map includes a database of radar returns, and the method includes the step of comparing ongoing radar returns with the radar returns in the database to detect matches or correlations therebetween. If the comparison detects a correlation or match, the return is categorized as anomalous propagation. However, if the comparison fails to detect a correlation or match, the return is categorized as an actual weather pattern. In preferred embodiments, the comparison is performed in real time. Spectral filtering may also be used to remove the anomalous propagation, if identified.

To utilize existing radar terminals, the operating range of the existing terminal is extended with a higher-efficiency radar transmitter, higher-sensitivity receiver, or both. The performance improvement is in the range of 6 to 10 dB, or at least 10 dB. The increased receiver sensitivity allows a greater volume of receive beam sampling and therefore an increased number of Doppler filter banks in which to detect and classify target primitives. This discovery increases, expands and extends the clutter map utilized to detect anomalous propagation.

### BRIEF DESCRIPTION OF THE DRAWINGS

FIG. 1 is a chart listing FAA current, prior-art radar inventory, including the ASR-8, ASR-9, and the more recent ASR-11;

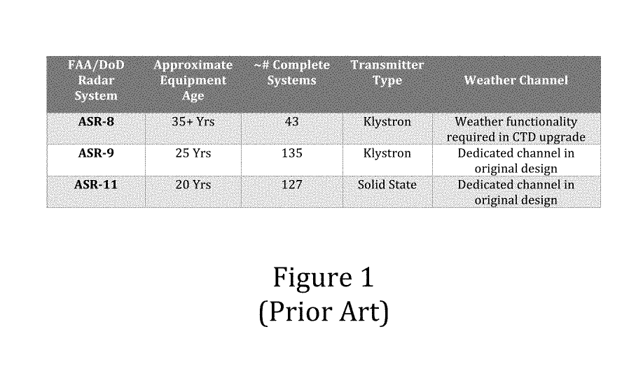

FIG. 2 illustrates a prior art ASR-9 Solution to Flag Ground Clutter Breakthrough Caused by Anomalous Propagation (Weber, 2002);

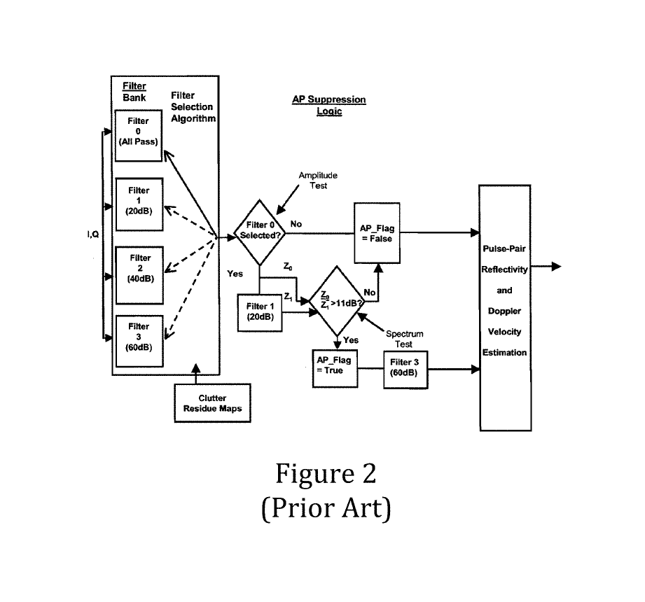

FIG. 3 is a prior-art comparison of Weather Cells from NWS (left) and Clutter from AP at a Terminal Radar Site (Prior Art);

FIG. 4 depicts a prior-art antenna Pattern and Ground Projection for 0 degrees of Antenna Rotation;

FIG. 5 is a diagram that illustrates a preferred embodiment of the invention wherein Extended Clutter Mapping is used to Assess Anomalous Propagation (AP);

FIG. 6 is a graph that shows prior art high- and low-beam patterns from a typical 2-beam airport surveillance radar; and

FIG. 7 is a prior-art diagram that shows the vertical amplitude and phase pattern of a production ASR-9 antenna. (Data measured by Westinghouse Electric Corp under contract to FAA.).

### DETAILED DESCRIPTION OF THE PREFERRED EMBODIMENTS

The oldest terminal radar in the NAS inventory, the ASR-8, is currently undergoing a significant upgrade that replaces the radar's receiver processing chain and digitizes the older analog system. There are significant differences between the ASR-8 and the newer radars that essentially preclude a straightforward application of the previous modification approaches to mitigate anomalous propagation. Unlike the other two radar types, ASR-9 and -11, the ASR-8 does not have a separate weather channel to exclusively process meteorological conditions, and the older style Klystron transmitter employed does not have the stability considered suitable for precise Doppler filtering. Additionally, the existing ASR-8 Moving Target Indicator (MTI) interrogation stagger arrangement is not fully conducive to accurate Doppler filtering of replies. Moreover, it is believed that previous modification approaches used for the ASR-9 and ASR-11 may inherently have a false anomalous propagation declaration rate (unreported real weather) that can be improved upon.

### ASR-8 AP Mitigation

The ASR-8 upgrade is known as the Common Terminal Digitizer (CTD) upgrade. As part of the upgrade, there is a requirement for six-level weather processing, and the CTD requirements pertaining to anomalous propagation are listed briefly as, “the CTD shall use algorithms to reduce incorrect WX reports resulting from clutter and AP.” (FAA, 2013, incorporated herein by reference).

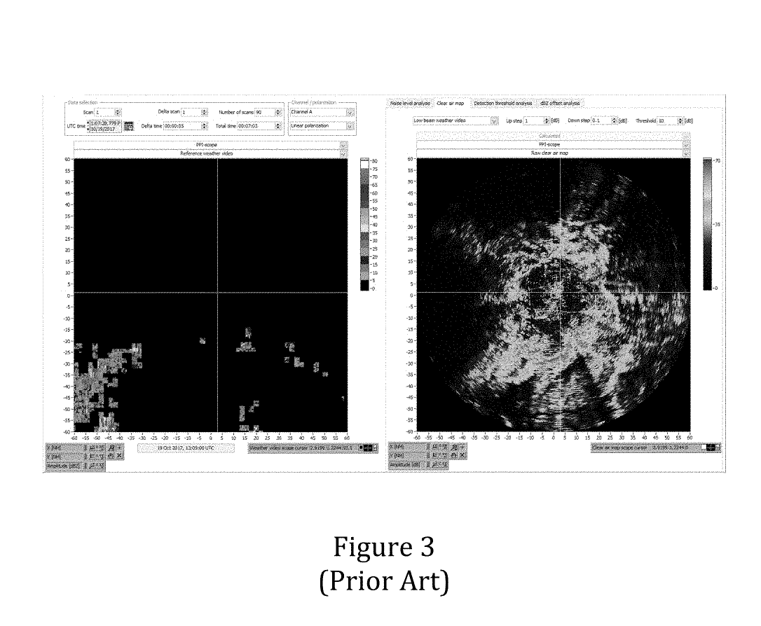

The clutter map in FIG. 3 (right panel) shows significant weather which is clearly AP when compared with data from the National Weather Service (NWS) on the same day (left panel). During these AP events, on-site staff observed misty conditions and low cloud cover which could partially indicate qualitative conditions causing AP. The NWS weather data on the left panel, shows only moderate weather within the range of the terminal radar.

One of the features of the CTD upgrade is that the receiver processor chain allows for an additional 7 dB processing gain, which is a significant improvement, as described in co-pending U.S. patent application Ser. No. 16/273,385, incorporated herein by reference in its entirety. This co-pending application also describes new advancements in transmitter technologies which can provide a further 2-3 dB improvement in efficiency, resulting in overall improvements in upgraded radar systems of approximately 10 dB. This extra 10 dB can be used in many ways as a trade off in the basic radar equations, such as improving range, or tracking smaller targets.

In accordance with this invention, it has also been discovered that this additional up-to-10 dB in range may be used to build extended radar clutter maps to improve the identification of anomalous propagation, or AP. In particular, with the new advantages inherent in the ASR-8's upgraded processing, it is possible to take an entirely new approach to mitigating the effects of anomalous propagation. This approach embraces, inter alia, extended range processing now available from the Common Terminal Digitizer (CTD) upgrade. Therefore, because of these significant architecture differences in the ASR-8 vis-a-vis the ASR-9 and ASR-11, an entirely different approach can be considered to counter anomalous propagation. The ASR-9 and ASR-11 spectral filtering approach is considered limited for the ASR-8 due to limitations in frequency stability, lack of a dedicated weather channel, and a Klystron MTI stagger set-up that is not optimized for precise Doppler measurement. Advances in the new ASR-8 processing, as a result of the CTD upgrade, allow for a newer approach, which is not available with the ASR-9 and ASR-11. These AP mitigation benefits are not limited to the ASR-8 radar, but apply to any radar that receives upgrades similar to those slated or potentially available for the ASR-8 (current receiver processor and potential transmitter upgrades).

### Extended Clutter Mapping for AP Mitigation

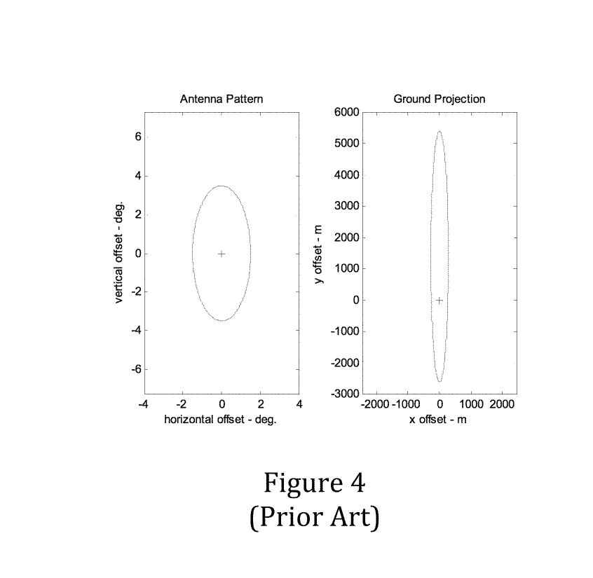

When a radar is operating in normal clear-air mode, it can build an accurate clutter map around the area of coverage. However, when AP exists and the beam “ducts,” it produces false returns from the ground which are incorrectly interpreted as clutter returns from weather. Consider the antenna beam as it illuminates the surface area around the radar, as depicted in FIG. 4, by Doerry, A. Clutter in the GMTI Range-Velocity Map, SAR Applications Department, Sandia National Laboratories, April 2009, incorporated herein by reference.

The clutter from existing topography is used to build a clutter map, which is used as reference to distinguish from other radar returns, such as weather. The problem with AP is that the beam is “ducted” often further from the radar and detects different clutter conditions, which is then reported, falsely, as weather.

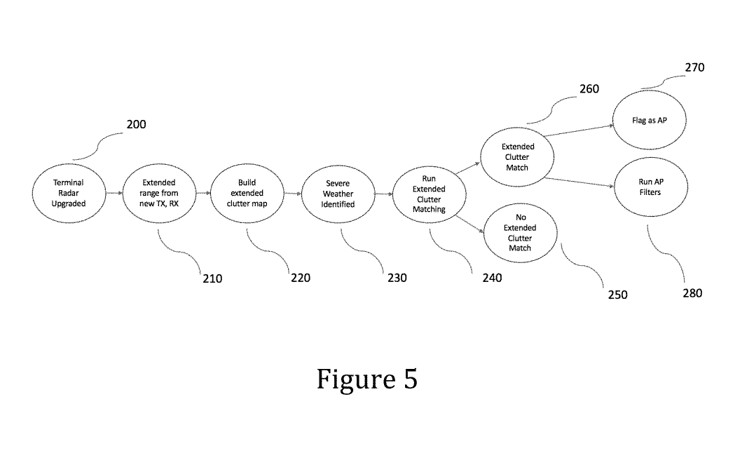

In accordance with one embodiment of this invention, diagrammed in FIG. 5, the extended range capability of the radar system is used to build extended clutter maps significantly beyond the normal operating range of the radar. These extended maps are then used to identify where AP may be falsely reporting ground clutter in the extended range as weather.

Making direct reference to FIG. 5, consider an upgraded terminal radar 200 which has a higher sensitivity receiver processor and more efficient transmitter, providing up to 10 dB gain. This 10 dB improvement may be used to provide an extended range 210, which in turn can be used to build a clutter map significantly beyond the required operational range of the radar 220. Normal terminal radar systems are required to operate out to 60 nm (nautical miles), whereas an improved system can extend significantly beyond this area. The extended clutter map constructed in accordance with this invention is essentially a database depiction of radar returns in a grid-like fashion, known as radar cells, which can be used for pattern matching.

When severe weather is detected at 230, a real-time assessment of extended clutter matching in the antenna boresight is performed to detect matches with the extended clutter map database. Antenna boresight in this context refers to the axis of maximum gain (maximum radiated power) of the directional radar antenna. If there is a match, or substantial correlation (260), the return is flagged as AP. If there is no match at 250, the return is categorized as “real” weather. Additionally, when AP is flagged at 270, it is also possible to apply spectral filtering to remove the AP, which would otherwise remove “real” weather in a non-AP event.

### Extended Clutter Map and Database Pattern Matching

Typical 2-beam surveillance radar systems have a low-beam and a high-beam where the low-beam is used for long range detections while the high-beam is used for short range detections. During operation, these radars switch between frequency-modulated long and short pulses, which are transmitted through the low-beam. The receiver then switches between signals from both feed horns as it collects long- and short-range returns.

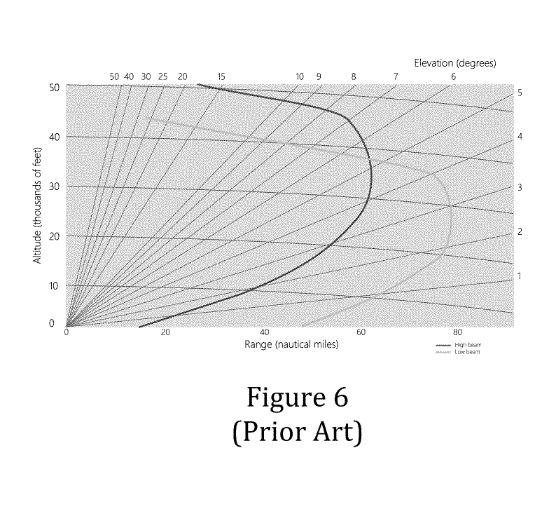

As the low-beam is directed at the horizon, this beam is most susceptible to typical ground clutter (FIG. 6). Most manufacturers use a combination of Doppler filter banks and clutter maps, such as the zero-velocity filter and the nonzero Doppler velocity filter, to remove clutter usually detected in normal operations. For these typical systems, there is no way to compare differences between beams. In practical application, both beams can be affected by anomalous propagation.

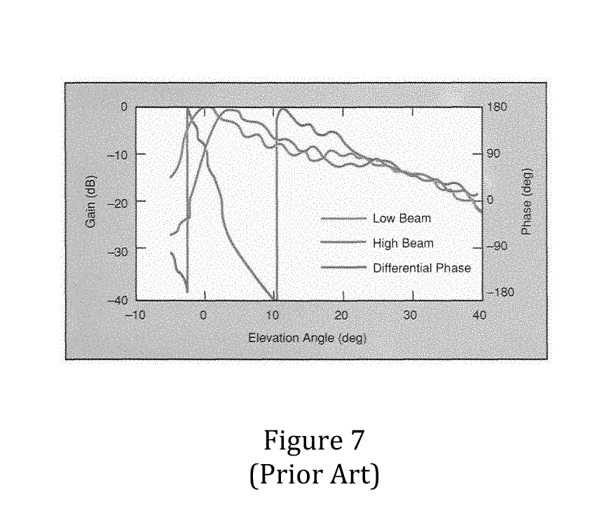

By simultaneously processing both beams using an extended Doppler filter bank and taking into account target altitude derived from calculating amplitude and phase differences (FIG. 7), it is now possible to eliminate those returns that are a combination of low (i.e., less than an adaptable) altitude and not detected in both the high- and low-beam. These techniques shown in FIGS. 6 and 7 are described in M. L. Stone and J. R. Anderson, “Advances in Primary-Radar Technology,” The Lincoln Laboratory Journals, Volume 2, Number 3 (1989), incorporated herein by reference.

In accordance with this invention, as discussed above, improved processing power, in addition to increased receiver sensitivity allows a greater volume of receive beam sampling and therefore an increased number of Doppler filter banks in which to detect and classify target primitives. This discovery increases, expands and extends the clutter map utilized to detect anomalous propagation.

1. A method of minimizing the effects of radar anomalous propagation for air traffic control, comprising the steps of:
providing a radar terminal including a radar transmitter and a radar receiver having an operating range;
improving the performance of the radar transmitter, the radar receiver, or both the transmitter and receiver to provide an extended operating range;
using the extended range to build an extended clutter map; and
using the extended clutter map to identify areas in radar returns where anomalous propagation may be falsely reporting ground clutter as weather.

2. The method of claim 1, wherein the extended clutter map includes a database of radar returns, and wherein the method includes the step of comparing ongoing radar returns with the radar returns in the database to detect matches or correlations therebetween.

3. The method of claim 2 wherein:
if the comparison detects a correlation or match, the return is categorized as anomalous propagation; and
if the comparison fails to detect a correlation or match, the return is categorized as an actual weather pattern.

4. The method of claim 2, wherein the comparison is performed in real time.

5. The method of claim 2, wherein the radar returns in the extended clutter map are arranged in a grid-like pattern of radar cells.

6. The method of claim 1, including the step of applying spectral filtering to remove the anomalous propagation if identified.

7. The method of claim 1, wherein the performance improvement is in the range of 6 to 10 dB.

8. The method of claim 1, wherein the performance improvement is at least 10 dB.

9. The method of claim 1, wherein the step of improving the performance of the radar transmitter includes increasing the efficiency of the transmitter.

10. The method of claim 1, wherein the step of improving the performance of the radar receiver includes increasing the efficiency of the receiver.
